(19) United States
(12) Patent Application Publication
(10) Pub. No.: US 2011/0177405 A1
(43) Pub. Date: Jul. 21, 2011

(54) FUEL CARTRIDGE AND HYDROGEN STORAGE METHOD

(75) Inventors: Kuo-Tai Hung, Hsinchu County (TW); Cheng Wang, Hsinchu County (TW); Po-Kuei Chou, Hsinchu County (TW)

(73) Assignee: YOUNG GREEN ENERGY CO., HSINCHU COUNTY (TW)

(21) Appl. No.: 12/958,414

(22) Filed: Dec. 2, 2010

(30) Foreign Application Priority Data
Jan. 15, 2010 (CN) 201010002986.8

(51) Int. Cl. H01M 8/06

(52) U.S. Cl. 429/416

(57) ABSTRACT

A fuel cartridge and a hydrogen storage method are provided. The fuel cartridge includes a plurality of reaction units. Each of the reaction units includes a first reactant, a second reactant, and a heating apparatus. The first reactant and the second reactant are separated from each other. The heating apparatus is capable of making the first reactant and the second reactant separated from each other contact with each other to generate hydrogen gas.

### CROSS-REFERENCE TO RELATED APPLICATION

This application claims the priority benefit of China application serial no. 201010002986.8, filed on Jan. 15, 2010. The entirety of the above-mentioned patent application is hereby incorporated by reference herein and made a part of this specification.

### BACKGROUND OF THE INVENTION

1. Field of the Invention

The invention relates to a fuel cartridge and a hydrogen storage method. More particularly, the invention relates to a fuel cartridge having a heating apparatus and a hydrogen storage method using the fuel cartridge.

2. Description of Related Art

Development and application of energy are always indispensable in our daily lives, while development and application of conventional energy sources lead to increasing environmental destruction. Fuel cell-based power generation characterized by high efficiency, low noise, and non-pollution complies with the energy trend.

A fuel cell may be categorized into a proton exchange membrane fuel cell (PEMFC) and a direct methanol fuel cell (DMFC). In the PEMFC, for example, a fuel cell module includes a proton exchange membrane, a cathode, and an anode. The cathode and the anode are respectively disposed at two sides of the proton exchange membrane and exposed in different reactants. At the anode of the PEMFC, hydrogen molecules react with an anode catalyst to generate hydrogen ions (H⁺) and electrons (e⁻), which may be represented by the following chemical formula: 2H₂→4H⁺+4e⁻. The generated electrons at the anode are transported to the cathode after flowing through an external circuit, such that the electrons may be applied to a load to work. The generated hydrogen ions at the anode are supplied to the cathode through the proton exchange membrane, and the hydrogen ions react with oxygen molecules and the electrons flowing through the external circuit at the cathode, so as to produce water, which may be represented by the following chemical formula: 4H⁺+4e⁻+O₂→2H₂O. To sum up, the complete chemical reaction formula of PEMFC is 2H₂+O₂→2H₂O.

It may be learned from the above that hydrogen gas acts as the fuel at the anode of the PEMFC. Accordingly, how to generate and carry the hydrogen gas in the fuel cell system is a major concern. Conventionally, a hydrogen cylinder or a metallic hydrogen storage tank is used to carry the hydrogen gas. In an alternative, fossil fuel could be converted into the hydrogen gas. However, the aforesaid solutions to carry the hydrogen gas are hardly feasible because of bulkiness and complexity of the system. Besides, the flow rate must remain constant during hydrogen reaction at the anode, which requires control from complicated valves and pumps. In most cases, the stored hydrogen gas is transported to an anode channel by the pumps and the flow control valves. The excessive active devices in the system thus result in difficulty of miniaturization and cost reduction.

At present, the fuel cartridge in the fuel cell system mainly supplies the hydrogen gas required for generating electric power for the fuel cell. In general, the conventional fuel cartridge adopts one-time reactive boron-based compound hydrogen storage technology, and water is added in the process of chemical reaction for constantly generating the hydrogen gas which is supplied to the fuel cell. However, the conventional fuel cartridge is designed to merely have one large chamber, and the boron-based compound hydrogen storage technology applied in the conventional fuel cartridge results in the one-time chemical reaction. Accordingly, the hydrogen gas is constantly produced until the chemical reaction of NaBH₄ fuel and water (H₂O) is completed. The one-time reactive fuel cartridge which continuously supplies the fuel cell with the hydrogen gas often gives rise to waste of the hydrogen gas and electric power, which means that the hydrogen gas supplied by the fuel cartridge could not be fully utilized.

### SUMMARY OF THE INVENTION

The invention is directed to a fuel cartridge and a hydrogen storage method by which quantity of hydrogen gas in the fuel cartridge may be actively controlled to achieve a high hydrogen gas storage rate.

Numerous features and advantages of the invention may be better understood by referring to the disclosure herein.

In an embodiment of the invention, a fuel cartridge including a plurality of reaction units is provided. Each of the reaction units includes a first reactant, a second reactant, and a heating apparatus. The first reactant and the second reactant are separated from each other. The heating apparatus is capable of making the first reactant and the second reactant separated from each other contact with each other to generate hydrogen gas.

In another embodiment of the invention, a hydrogen storage method including following steps is provided. A fuel cell system including a fuel cell stack and a fuel cartridge is provided. The fuel cartridge has a plurality of reaction units, each of the reaction units includes a first reactant, a second reactant, and a heating apparatus. The first reactant and the second reactant are separated from each other. Electric quantity of the fuel cell stack is detected. When the electric quantity of the fuel cell stack is insufficient, a first hydrogen generation reaction is performed based on power consumption of the fuel cell stack. The first hydrogen generation reaction includes steps of controlling at least one of the heating apparatuses in at least one of the reaction units to perform heating, such that the first reactant and the second reactant in the at least one of the reaction units contact with each other to generate an adequate quantity of hydrogen gas. The fuel cell stack is supplied with the hydrogen gas generated by performing the first hydrogen generation reaction.

Based on the above, the embodiments of the invention have at least one of the advantages described below. The fuel cartridge has a plurality of reaction units, and the first reactant and the second reactant in each of the reaction units are separated from each other. When the electric quantity of the fuel cell stack is detected to be insufficient, the heating apparatus in one of the reaction units or the heating apparatuses in more of the reaction units may be activated based on power consumption of the fuel cell stack to perform heating, such that the first and second reactants separated from each other contact with each other to perform the chemical reaction by which an adequate quantity of hydrogen gas may be generated and supplied to the fuel cell stack. That is to say, the hydrogen gas may be supplied through the stepped chemical reaction of the first and the second reactants rather than through the one-time chemical reaction, which may prevent the waste of the hydrogen gas.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating arrangement of a fuel cell system according to an embodiment of the invention.

FIG. 2 is a schematic flowchart illustrating a hydrogen storage method according to an embodiment of the invention.

FIG. 3A is a schematic top view illustrating a fuel cartridge according to an embodiment of the invention.

FIG. 3B and FIG. 3C are schematic cross-sectional views illustrating operation of the fuel cartridge along a line segment I-I′ depicted in FIG. 3A.

FIG. 4 and FIG. 5 are schematic cross-sectional views illustrating a fuel cartridge according to another embodiment of the invention.

FIG. 6 is a schematic cross-sectional view illustrating a fuel cartridge according to an embodiment of the invention.

FIG. 7A and FIG. 7B are schematic cross-sectional views illustrating operation of a reaction unit in a fuel cartridge according to an embodiment of the invention.

FIG. 8 is a schematic cross-sectional view illustrating a reaction unit in a fuel cartridge according to another embodiment of the invention.

FIG. 9A and FIG. 9B are schematic cross-sectional views illustrating operation of a reaction unit in a fuel cartridge according to an embodiment of the invention.

FIG. 10A and FIG. 10B are schematic cross-sectional views illustrating operation of a reaction unit in a fuel cartridge according to another embodiment of the invention.

FIG. 11A and FIG. 11B are schematic cross-sectional views illustrating operation of a reaction unit in a fuel cartridge according to an embodiment of the invention.

FIG. 12A and FIG. 12B are schematic cross-sectional views illustrating operation of a reaction unit in a fuel cartridge according to another embodiment of the invention.

FIG. 13A and FIG. 13B are schematic cross-sectional views illustrating operation of a reaction unit in a fuel cartridge according to another embodiment of the invention.

FIG. 14A and FIG. 14B are schematic cross-sectional views illustrating operation of a reaction unit in a fuel cartridge according to another embodiment of the invention.

FIG. 15A and FIG. 15B are schematic cross-sectional views illustrating operation of a reaction unit in a fuel cartridge according to another embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

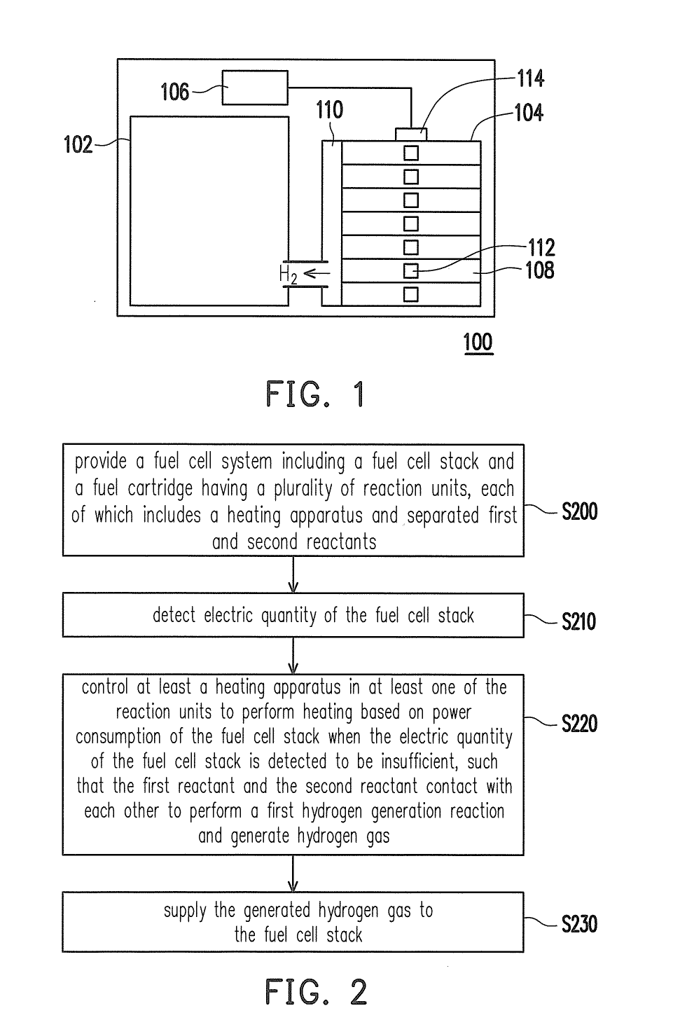

FIG. 1 is a schematic view illustrating arrangement of a fuel cell system according to an embodiment of the invention. FIG. 2 is a schematic flowchart illustrating a hydrogen storage method according to an embodiment of the invention.

With reference to FIG. 1 and FIG. 2, according to the hydrogen storage method depicted in this embodiment of the invention, a fuel cell system 100 is provided (step S200). The fuel cell system 100 includes a fuel cell stack 102 and a fuel cartridge 104. The fuel cell stack 102 is connected to the fuel cartridge 104 and uses hydrogen gas supplied by the fuel cartridge 104 for power generation. Here, the fuel cell stack 102 is, for example, a PEMFC, which is however not limited in this invention.

The fuel cartridge 104 includes a plurality of reaction units 108 and a hydrogen gas channel 110. Each of the reaction units 108 includes a first reactant, a second reactant, and a heating apparatus 112. The first reactant and the second reactant are separated from each other. The heating apparatus 112 is, for example, a resistor or an electrically heated wire. Each of the heating apparatuses 112 in the corresponding one of the reaction units 108 may perform heating, for instance, such that the separated first and second reactants contact with each other to perform the chemical reaction by which the hydrogen gas may be generated.

The first reactant includes a chemical hydrogen storage material in form of solid fuel, for instance. According to an embodiment, the chemical hydrogen storage material is selected from the group consisting of metal, metal hydride, borohydride, aluminum hydride, hydrocarbon, and ammonium hydride. Here, the chemical hydrogen storage material may have metal elements in group IA, group IIA, or group IIIA. For instance, the chemical hydrogen storage material may be Mg, Al, Na, Li, Ca, CaH₂, MgH₂, LiH, AlH₃, BeH₂, NaH, LiAlH₄, LiBH₄, NaBH₄, and so on, which should not be construed as a limitation to this invention. The second reactant includes a hydro-reactant, for example, water (H₂O). Specifically, the hydro-reactant may be liquid water or solid water. The solid water may be referred to as a super water-absorbent material that absorbs water having a weight 10 to 300 times of the weight of the super water-absorbent material itself.

Besides, catalysts are mixed in the first reactants in advance, for example. As such, when each of the heating apparatuses 112 in the corresponding one of the reaction units 108 performs heating, the separated first and second reactants contact with each other, and thus the chemical reaction may be performed to generate the hydrogen gas. Each of the reaction units 108 has a constant amount of the first and the second reactants, such that the chemical reaction may be completely performed, and that a high hydrogen gas storage rate may be accomplished. A mole ratio of the first reactant to the second reactant in each of the reaction units 108 may approximately range from 1:2 to 1:6. During the reaction between the first and the second reactants, the reaction temperature in each of the reaction units 108 approximately ranges from the room temperature to 150° C., for example.

The fuel cartridge 104 further includes an external control circuit 106. The external control circuit 106 is connected to the fuel cartridge 104, so as to selectively control at least one of the heating apparatuses 112 in at least one of the reaction units 108 to conduct electricity and perform heating. The external control circuit 106 may include a micro controller unit (MCU), a control switch, and an interface connecting the fuel cartridge 104. In an embodiment, the fuel cartridge 104 may have an interface 114 connecting the external control circuit 106, and the interface 114 is, for example, a golden finger or a connector. The heating apparatus 112 in each of the reaction units 108 is electrically connected to the interface 114 that connects the external control circuit 106, such that the external control unit 106 is able to control the heating apparatus 112 in one of the reaction units 108 or the heating apparatuses 112 in more of the reaction units 108 for further hydrogen generation reaction.

In step S210, electric quantity of the fuel cell stack 102 is detected. When the electric quantity of the fuel cell stack 102 is detected to be insufficient, a hydrogen generation reaction is performed based on power consumption of the fuel cell stack 102. In the hydrogen generation reaction, the external control unit 106 controls the heating apparatus 112 in one of the reaction units 108 or the heating apparatuses 112 in more of the reaction units 108 to perform heating (step S220). In an embodiment, when the heating apparatuses 112 in the reaction units 108 are controlled to perform heating, each of the reaction units 108 is separated from one another. Through heating, the separated first and second reactants in the corresponding reaction units 108 contact with each other to perform the chemical reaction by which the hydrogen gas may be generated. The generated hydrogen gas is supplied to the fuel cell stack 102 through the hydrogen gas channel 110 (S230).

Besides, in an embodiment, the step S210 to the step S230 may be repeatedly performed after the hydrogen gas is supplied to the fuel cell stack 102 (step S230). Thereby, the electric quantity of the fuel cell stack 102 may be continuously monitored, and another hydrogen generation reaction may be performed based on another power consumption of the fuel cell stack 102. Specifically, the heating apparatus 112 in another one of the reaction units 108 or the heating apparatuses 112 in more of the reaction units 108 may be controlled by the external control circuit 106 based on another power consumption of the fuel cell stack 102 to perform heating, so as to generate an adequate quantity of hydrogen gas. It should be mentioned that the one or more reaction units 108 used in the later hydrogen generation reaction is different from and separated from the one or more reaction units 108 used in the earlier hydrogen generation reaction. Namely, the reaction units 108 respectively used in the sequentially-performed two hydrogen generation reactions are not adjacent to one another. Therefore, the efficiency of the reactions is not affected because the heat generated in the two reactions is prevented from being conducted to the surroundings.

Note that the fuel cartridge 104 has the reaction units 108, and the external control circuit 106 may be manipulated to control the heating apparatus 112 in one of the reaction units 108 or the heating apparatuses 112 in more of the reaction units 108 for further hydrogen generation reaction. When the total electric power consumption of the fuel cell stack 102 attains a predetermined value, the heating apparatus 112 may be controlled based on the power consumption of the fuel cell stack 102, such that the first reactant may react with the second reactant, and that the hydrogen gas may be generated and supplied to the fuel cell stack 102. As such, the hydrogen gas generated by each of the reaction units 108 in the fuel cartridge 104 may be fully utilized by the fuel cell stack 102 without being wasted.

The fuel cartridge is further described with reference to top views and cross-sectional views of the fuel cartridge according to several embodiments of the invention. Note that the arrangement and the structure of the fuel cartridge described in the following embodiments do not pose limitations to the scope of the invention but allow people skilled in the art to fulfill the invention. It is apparent to those skilled in the art that various modifications may be made to the arrangement and the structure of the fuel cartridge without departing from the scope the invention as long as the separated first and second reactants contact with each other to generate hydrogen gas by using the heating apparatus. In addition, the first reactant, the second reactant, and the heating apparatus described in the following embodiments are similar to those provided in the previous embodiments, and therefore detailed description is omitted herein.

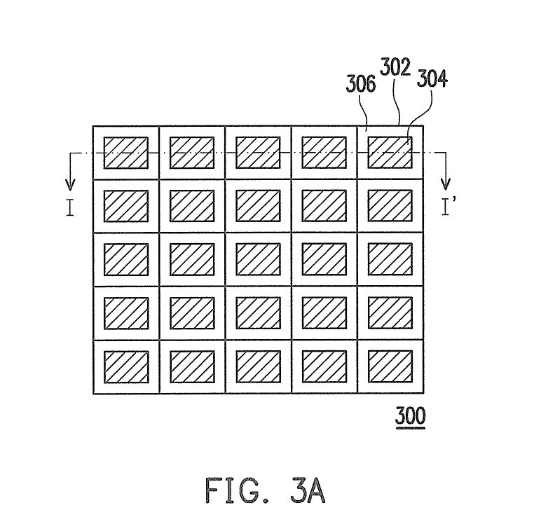

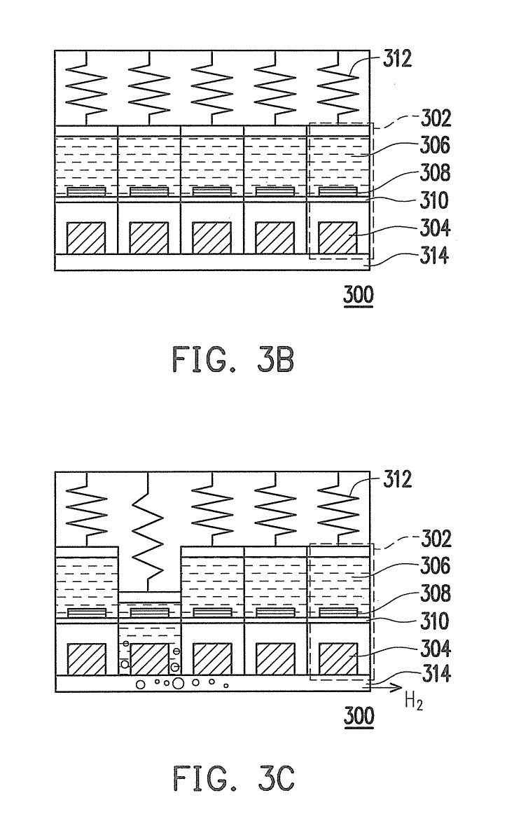

FIG. 3A is a schematic top view illustrating a fuel cartridge according to an embodiment of the invention. FIG. 3B and FIG. 3C are schematic cross-sectional views illustrating operation of the fuel cartridge along a line segment I-I′ depicted in FIG. 3A.

Referring to FIG. 3A and FIG. 3B, the fuel cartridge 300 includes a plurality of reaction units 302. The reaction units 302 may be arranged in an array as shown in FIG. 3A or the reaction units 302 and separators (not shown) may be arranged in an alternate manner. That is to say, separators may be disposed between the adjacent reaction units 302, so as to prevent heat generated in the reaction from being conducted to the neighboring reacting units 302. Besides, the number of the reaction units 302 may be adjusted by request, which should not be limited to the number depicted in the drawings. Each of the reaction units 302 includes a first reactant 304, a second reactant 306, and a heating apparatus 308. The first reactant 304 and the second reactant 306 are separated from each other. Each of the reaction units 302 has a constant amount of the first reactant 304 and the second reactant 306, for example, such that the chemical reaction may be completely performed, and that a high hydrogen gas storage rate may be accomplished. By means of the heating apparatus 308, the separated first and second reactants 304 and 306 in the corresponding one of the reaction units 302 contact with each other to perform the chemical reaction by which the hydrogen gas may be generated.

Specifically, as shown in FIG. 3B, the first reactant 304 and the second reactant 306, for example, are individually disposed in a chamber, and a thin film 310 is used to separate the first reactant 304 from the second reactant 306. The chambers of the adjacent reaction units 302 are not connected to one another, for instance. Namely, each of the adjacent reaction units 302 respectively has a closed chamber in which the first reactant 304 and the second reactant 306 are disposed. The thin film 310 is made of a material which does not react with the first reactant 304 and the second reactant 306. Besides, the material of the thin film 310 does not contain metal ions, for example. The thin film 310 may be made of polymer, a wax film, and so on. A melting point of the thin film 310 ranges from 40° C. to 200° C., for instance.

According to an embodiment, the periphery of the first reactant 304 may be filled with a super water absorbent material (not shown) which is conducive to preventing the second reactant 306 from leaking and flowing to the fuel cell stack. Thereby, the performance of the fuel cell is not deteriorated.

The heating apparatus 308 is disposed on a surface of the thin film 310 and melts the thin film 310 by heating for forming holes, such that the first reactant 304 and the second reactant 306 in the corresponding reaction unit 302 contact with each other through the holes, and the hydrogen gas may be generated in the reaction. The heating apparatus 308 is, for example, a resistor or an electrically heated wire, and an outer surface of the heating apparatus 308 may be alternatively encapsulated by a protection material, so as to prevent the reactants from contacting of the resistor.

The fuel cartridge 300 may further include at least a pressing mechanism 312 and a hydrogen gas channel 314. As shown in FIG. 3B, a pressing mechanism 312 is correspondingly disposed over each of the reaction units 302, for example. The hydrogen gas channel 314 is connected to bottom portions of the reaction units 302. Here, the hydrogen gas channel 314 is connected to the fuel cell stack, so as to supply the hydrogen gas generated in the reaction units 302 to the fuel cell stack.

With reference to FIG. 3C, when electrical quantity of the fuel cell stack is detected to be insufficient, the heating apparatus 308 in one of the reaction units 304 or the heating apparatuses 308 in more of the reaction units 304 may be activated based on power consumption of the fuel cell stack to perform heating. In each of the reaction units 302, the thin film 310 is melted by heat of the heating apparatus 308 located on the surface of the thin film 310 to form holes, and the second reactant 306 located above the thin film 310 flows to the first reactant 304 through the holes for the chemical reaction. Thereby, an adequate quantity of the hydrogen gas may be generated. It should be mentioned that when the heating apparatus 308 melts the thin film 310 by heating, the pressing mechanism 312 may push the second reactant 306 to the first reactant 304 to cause a reaction of the first reactant 304 and the second reactant 306 completely. The generated hydrogen gas may be supplied to the fuel cell stack through the hydrogen gas channel 314 located below the reaction units 302.

In the embodiment shown in FIG. 3B and FIG. 3C, the second reactant 306 is exemplarily disposed over the first reactant 304 in each of the reaction units 302, which should not be construed as a limitation to this invention. According to other embodiments, the first reactant 304 may also be disposed over the second reactant 306. When the heating apparatus 308 melts the thin film 310 by heating, the pressing mechanism 312 pushes the first reactant 304 to the second reactant 306 to cause a reaction of the first reactant 304 and the second reactant 306 completely.

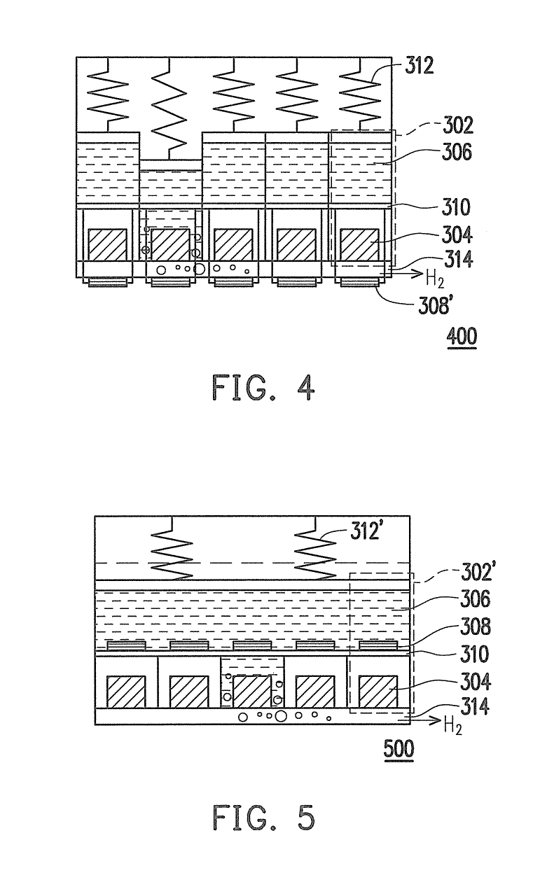

FIG. 4 and FIG. 5 are schematic cross-sectional views illustrating a fuel cartridge according to another embodiment of the invention. Same components in FIG. 4 and FIG. 5 and in FIG. 3B and FIG. 3C are marked by the same reference numbers, and relevant description is omitted herein.

According to another embodiment, the major components of the fuel cartridge 400 depicted in FIG. 4 are basically the same as those of the fuel cartridge 300 depicted in FIG. 3B and FIG. 3C, while the difference therebetween lies in the location of the heating apparatus. In FIG. 3B and FIG. 3C, the heating apparatus 308 is disposed on the surface of the thin film 310. By contrast, in FIG. 4, the heating apparatus 308′, for example, are disposed outside each of the chambers of the reaction units 302 and connected to the thin film 310 through wires. Accordingly, in the embodiment illustrated in FIG. 4, the thin film 310 is melted by the heating apparatus 308′ in each of the reaction units 302 to form holes, which the first reactant 304 and the second reactant 306 contact with each other to generate the hydrogen gas.

According to another embodiment, the major components of the fuel cartridge 500 depicted in FIG. 5 are basically the same as those of the fuel cartridge 300 depicted in FIG. 3B and FIG. 3C, while the difference therebetween lies in the arrangement of the pressing mechanism. In FIG. 3B and FIG. 3C, each of the pressing mechanisms 312 is correspondingly disposed over one of the reaction units 302. By contrast, in FIG. 5, pressing mechanism 312′ is commonly disposed over a plurality of reaction units 302′, for example.

Particularly, in the fuel cartridge 500, the chamber of each of the reaction units 302′ is partially connected. Namely, the second reactants 306 of the adjacent reaction units 302′ are together disposed in the same chamber, while the first reactants 304 are individually disposed in separated chambers. The pressing mechanism 312′ is disposed over the chamber in which the second reactants 306 of the reaction units 302′ are disposed. According to the embodiment depicted in FIG. 5, when the heating apparatus 308 in each of the reaction units 302′ performs heating and melts the thin film 310 to form holes, the pressing mechanism 312′ may push parts of the second reactants 306 to the first reactants 304 through the holes for causing a reaction of the second reactants 306 and the first reactants 304 completely and for further generation of the hydrogen gas. It should be mentioned that the first reactant 304 in each of the reaction units 302′ is respectively disposed in one of the separated chambers. Hence, an adequate quantity of the hydrogen gas may still be generated by controlling one or more reaction units 302′ to cause a reaction based on the required electric power of the fuel cell stack.

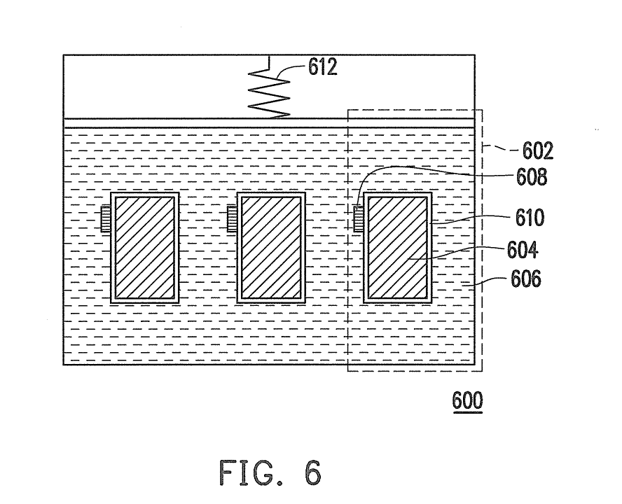

In other embodiments, note that the thin film separating the first reactant from the second reactant may have different configurations. The thin film has a closed space, for example. One of the first reactant and the second reactant is enclosed in the closed space, and the other is located outside the closed space. Detailed description is provided hereinafter. For better illustration, the reaction units in the fuel cartridge are depicted in the drawings according to the following embodiments, while other components of the fuel cartridge are omitted. FIG. 6 is a schematic cross-sectional view illustrating a fuel cartridge according to an embodiment of the invention.

In FIG. 6, the fuel cartridge 600 includes a plurality of reaction units 602. Each of the reaction units 602 includes a first reactant 604, a second reactant 606, and a heating apparatus 608. The first reactant 604 and the second reactant 606 are separated from each other by a thin film 610. In this embodiment, the first reactants 604 and the second reactants 606 are disposed in the same chamber, and each of the first reactants 604 is enclosed by the closed space of one of the thin films 610. The heating apparatus 608 is respectively disposed on a surface of each of the thin films 610, so as to melt the individual thin films 610 by heating and form holes. The first reactants 604 enclosed in the thin films 610 and the second reactants 606 located outside the thin films 610 contact with each other through the holes and then react to generate the hydrogen gas.

Because each of the first reactants 604 being enclosed by one of the thin films 610 and the heating apparatus 608 being correspondingly disposed on the surface of each of the thin films 610, thus at least one of the heating apparatuses 608 could be selectively controlled to perform heating for the reaction of the first reactants 604 with a constant amount and the second reactants 606, so as to generate an adequate quantity of the hydrogen gas in spite of the excess second reactants 606 and a plurality of the first reactants 604 being disposed in the same chamber.

In the embodiment depicted in FIG. 6, the first reactants 604 are exemplarily enclosed in the closed space of the thin films 610, while the closed space of the thin films 610 may also enclose the second reactants 606 according to other embodiment. At this time, the first reactants 604 are located outside the closed space.

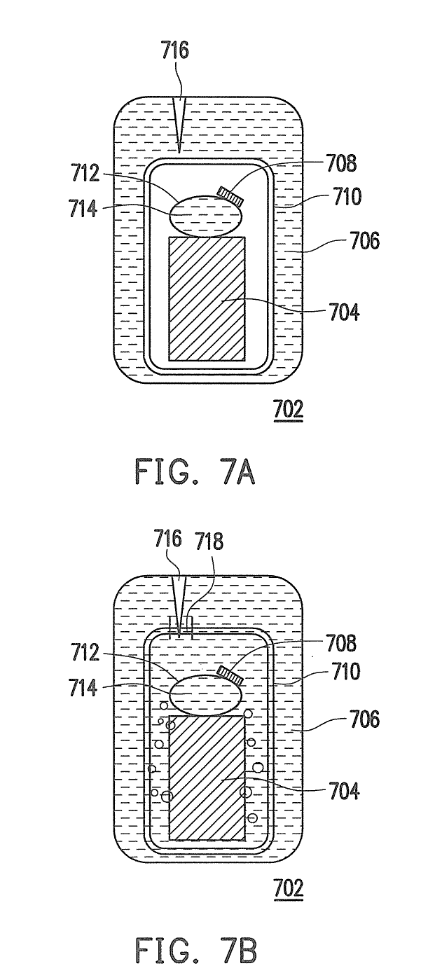

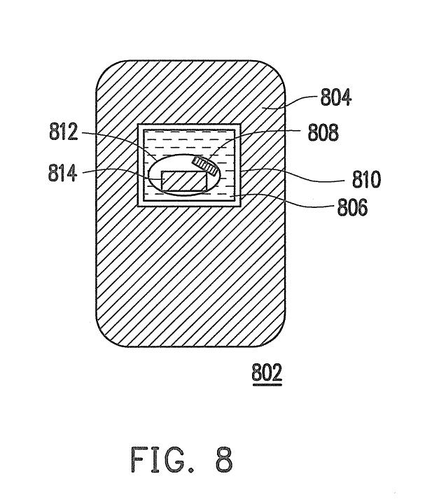

In addition, each of the reaction units of the fuel cartridge may further include a capsule disposed in the closed space of the thin film. The capsule has the first reactant or the second reactant, for example, and the reactant in the capsule is different from the reactant outside the capsule. The reaction units having the capsules are described below with reference to cross-sectional views. FIG. 7A and FIG. 7B are schematic cross-sectional views illustrating operation of a reaction unit in a fuel cartridge according to an embodiment of the invention.

In FIG. 7A, the fuel cartridge includes a plurality of reaction units 702. Each of the reaction units 702 includes a first reactant 704, a second reactant 706, and a heating apparatus 708. The first reactant 704 and the second reactant 706 are separated from each other by a thin film 710. The first reactant 704 is enclosed in the closed space formed by the thin film 710, while the second reactant 706 is disposed outside the closed space. In this embodiment, each of the reaction units 702 further includes a capsule 712 disposed in the closed space formed by the thin film 710. A reactant 714 is encapsulated by the capsule 712. Here, the reactant 714 in the capsule 712 may be the same as or different from the second reactant 706. In other words, the first reactant 704 and the capsule 712 encapsulating the reactant 714 are enclosed in the closed space formed by the thin film 710, and gas may be generated when the reactant 714 in the capsule 712 contacts with the first reactant 704. The capsule 712, for example, is disposed near the first reactant 704. The heating apparatus 708 is disposed on a surface of the capsule 712. A material of the capsule 712 is the same as or similar to a material of the thin film 710, for example. Besides, each of the reaction units 716 further includes a pointed member 716 disposed outside the closed space of the thin film 710.

With reference to FIG. 7B, when electrical quantity of the fuel cell stack is detected to be insufficient, the heating apparatus 708 in one of the reaction units 702 or the heating apparatuses 708 in more of the reaction units 702 may be activated based on power consumption of the fuel cell stack to conduct electricity and perform heating. In each of the reaction units 702, the capsule 712 is melted by heat of the heating apparatus 708 located on the surface of the capsule 712 to form holes, and the reactant 714 located in the capsule 712 flows out of the capsule 712 through the holes and infiltrates into a surface of the first reactant 704 for gas (e.g. hydrogen gas) generation reaction. It should be mentioned that the heating apparatus 708 melts the capsule 712 by heating, such that the reactant 714 in the capsule 712 reacts with the first reactant 704 to generate gas, and the generated gas inflates the thin film 710. At this time, the pointed member 716 penetrates the inflated thin film 710 to form holes 718, and the second reactant 706 located outside the closed space formed by the thin film 710 passes through the holes 718 and enters the closed space, such that the second reactant 706 constantly reacts with the first reactant 704 to generate the hydrogen gas.

The reactant 714 encapsulated by the capsule 712 may be the same as the second reactant 706 in the embodiment depicted in FIG. 7A to FIG. 7B, while the capsule in another embodiment may also encapsulate the first reactant or another reactant apart from the first and the second reactants. FIG. 8 is a schematic cross-sectional view illustrating a reaction unit in a fuel cartridge according to another embodiment of the invention.

In FIG. 8, the fuel cartridge includes a plurality of reaction units 802. Each of the reaction units 802 includes a first reactant 804, a second reactant 806, and a heating apparatus 808. The first reactant 804 and the second reactant 806 are separated from each other by a thin film 810. The second reactant 806 is enclosed in the closed space formed by the thin film 810, while the first reactant 804 is disposed outside the closed space. In this embodiment, each of the reaction units 802 further includes a capsule 812 disposed in the closed space formed by the thin film 810. A reactant 814 is encapsulated by the capsule 812. Herein, the reactant 814 in the capsule 812 may be the same as or different from the first reactant 804. That is to say, the second reactant 806 and the capsule 812 having the reactant 814 therein are both enclosed by the closed space formed by the thin film 810, and the capsule 812 is disposed near the second reactant 806, for example. The heating apparatus 808 is disposed on an inner surface of the capsule 812, for example. A material of the capsule 812 is the same as or similar to a material of the thin film 810, for example.

When electrical quantity of the fuel cell stack is detected to be insufficient, the heating apparatus 808 in one of the reaction units 802 or the heating apparatuses 808 in more of the reaction units 802 may be activated based on power consumption of the fuel cell stack to perform heating. The capsule 812 is melted by the heating apparatus 808 located on the surface of the capsule 812 to form holes, and the second reactant 806 located outside the capsule 812 infiltrates into the capsule 812 through the holes and reacts with the reactant 814 located in the capsule 812 for gas (e.g. hydrogen gas) generation. When the amount of generated gas increases, the thin film 810 may burst, or a pointed member (not shown) located outside the closed space of the thin film 810 may penetrate the thin film 810 to form holes. Therefore, the second reactant 806 located in the closed space formed by the thin film 810 flows out of the closed space and constantly reacts with the first reactant 804 for hydrogen gas generation.

In addition to the previous embodiments, the invention may be fulfilled based on the following embodiments as well. The heating apparatus which melts the thin film or the capsule to form the holes is used in the previous embodiments, such that the first reactant and the second reactant contact with each other, which should however not be construed as a limitation to this invention. The thin film may also be penetrated by a thin film destruction mechanism according to other embodiments as long as the heating apparatus is employed to control the reaction units 108 for further hydrogen generation reaction. Detail description is provided hereinafter.

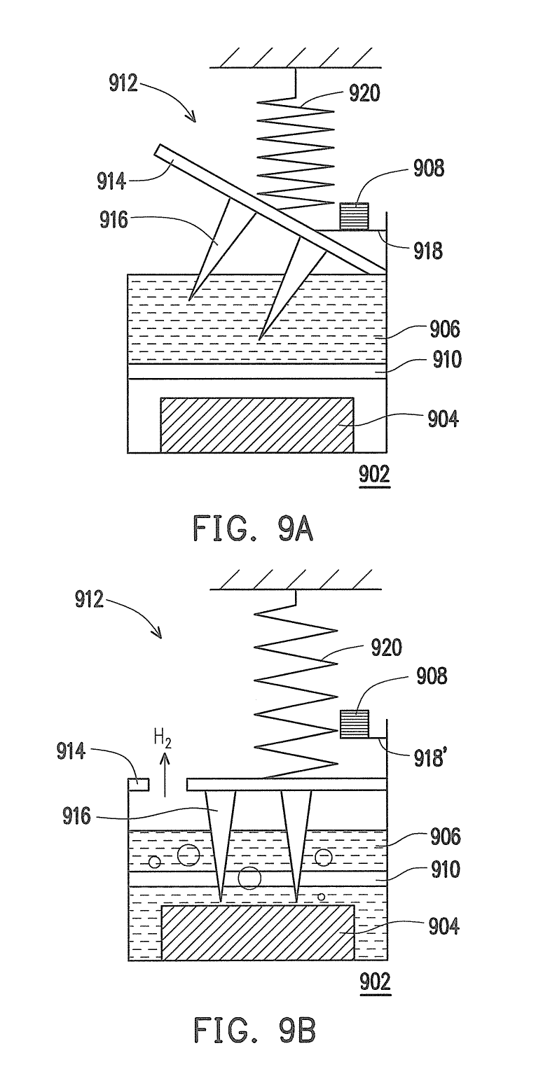

FIG. 9A and FIG. 9B are schematic cross-sectional views illustrating operation of a reaction unit in a fuel cartridge according to an embodiment of the invention.

In FIG. 9A, the fuel cartridge includes a plurality of reaction units 902. Each of the reaction units 902 includes a first reactant 904, a second reactant 906, and a heating apparatus 908. The first reactant 904 and the second reactant 906 are separated from each other by a thin film 910. Each of the reaction units 902 further includes a thin film destruction mechanism 912 exemplarily having pointed members 916 to penetrate the thin film 910, such that the first reactant 904 and the second reactant 906 separated by the thin film 910 contact with each other. In an embodiment, the thin film destruction mechanism 912 includes a connection rod 914 with the pointed members 916, a connection portion 918, and an elastic member 920. The elastic member 920 connects the connection rod 914 to exert an elastic force on the connection rod 914. Here, the elastic member 920 is, for example, a spring. The connection portion 918 connects the connection rod 914 to press the elastic member 920 and fix the connection rod 914 at a first position. In this embodiment, the connection rod 914 is fixed at a side of the reaction unit 902 by the connection portion 918, such that one end of the connection rod 914 is raised, and the pointed members 916 connected to the connection rod 914 are located above the thin film 910. The heating apparatus 908 is disposed on the connection portion 918, for example. The connection portion 918 may be made of polymer, a wax film, and so on. In this embodiment, the connection portion 918, for example, is a plastic rope, which should not be construed as a limitation to this invention.

With reference to FIG. 9B, when electrical quantity of the fuel cell stack is detected to be insufficient, the heating apparatus 908 in one of the reaction units 902 or the heating apparatuses 908 in more of the reaction units 902 may be activated based on power consumption of the fuel cell stack to perform heating. In each of the reaction units 902, the connection portion 918′ is melted by the heat of the heating apparatus 908 located on the connection portion 918′, such that the connection rod 914 fixed by the connection portion 918′ is released. The connection rod 914 is moved from the first position to a second position with gravity, such that the pointed members 916 on the connection rod 914 penetrate the thin film 910. Thereby, the second reactant 906 passes through the penetrated thin film 910 and reacts with the first reactant 904 to generate hydrogen gas.

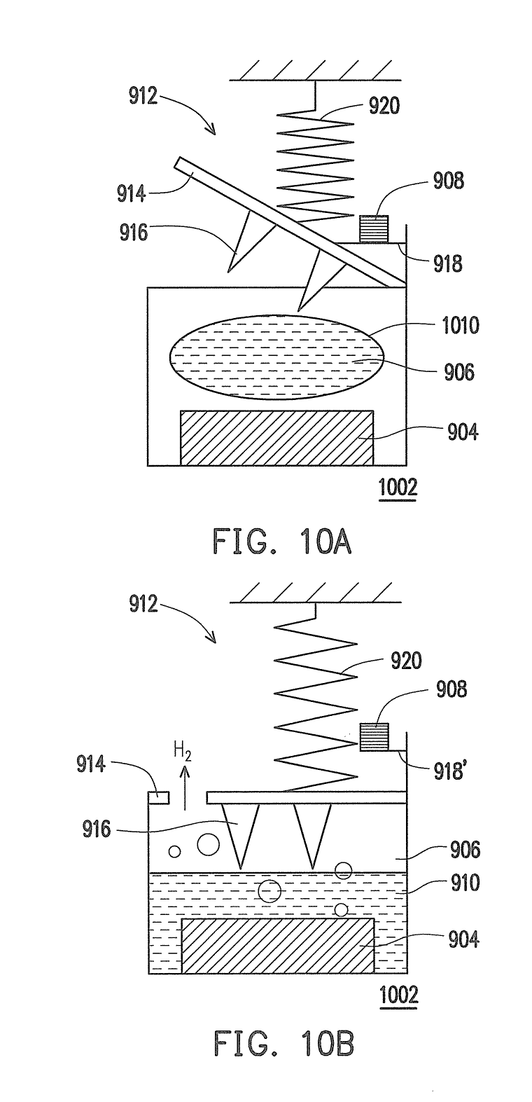

In other embodiments, the thin film separating the first reactant from the second reactant may have a closed space. FIG. 10A and FIG. 10B are schematic cross-sectional views illustrating operation of a reaction unit in a fuel cartridge according to another embodiment of the invention. Same components in FIG. 10A and FIG. 10B and in FIG. 9A and FIG. 9B are marked by the same reference numbers, and relevant description is omitted herein.

According to another embodiment, the major components of the reaction units 1002 depicted in FIG. 10A are basically the same as those of the reaction units 902 depicted in FIG. 9A, while the difference therebetween lies in the structure of the thin film. In FIG. 10A, the thin film 1010 has a closed space, for example, and the second reactant 906 is enclosed in the closed space.

Likewise, in FIG. 10B, when the connection portion 918′ is melted by the heat of the heating apparatus 908 located on the connection portion 918′, the connection rod 914 fixed by the connection portion 918′ is released. Due to gravity, the connection rod 914 is moved from the first position to the second position. As such, the pointed members 916 on the connection rod 914 penetrate the thin film 1010, and the second reactant 906 enclosed by the closed space formed by the thin film 1010 passes through the penetrated thin film 1010 and reacts with the first reactant 904 to generate the hydrogen gas.

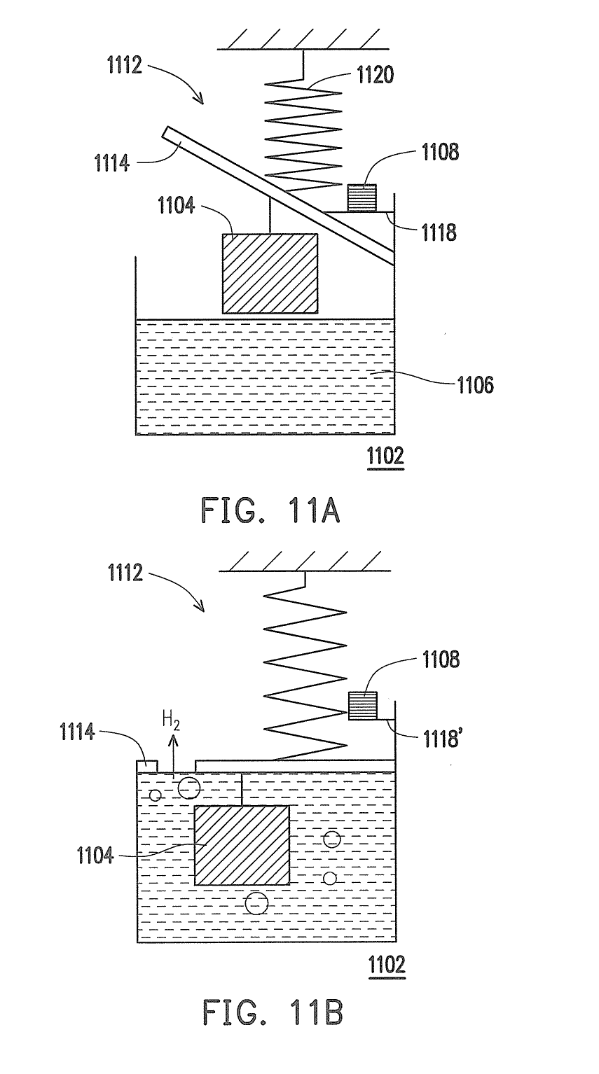

FIG. 11A and FIG. 11B are schematic cross-sectional views illustrating operation of a reaction unit in a fuel cartridge according to another embodiment of the invention.

In FIG. 11A, the fuel cartridge includes a plurality of reaction units 1102. Each of the reaction units 1102 includes a first reactant 1104, a second reactant 1106, and a heating apparatus 1108. The first reactant 1104 and the second reactant 1106 are separated from each other. Each of the reaction units 1102 further includes a fixing mechanism 1112 for separating the first reactant 1104 from the second reactant 1106, for example. In an embodiment, the fixing mechanism 1112 includes a connection rod 1114 connecting the first reactant 1104, a connection portion 1118, and an elastic member 1120. The elastic member 1120 connects the connection rod 1114 to exert an elastic force on the connection rod 1114. Here, the elastic member 1120 is, for example, a spring. The connection portion 1118 connects the connection rod 1114 to press the elastic member 1120 and fix the connection rod 1114 at a first position. In this embodiment, the connection rod 1114 is fixed at a side of the reaction unit 1102 by the connection portion 1118, such that one end of the connection rod 1114 is raised, and the first reactant 1104 connecting a bottom portion of the connection rod 1114 does not contact with the second reactant 1106. The heating apparatus 1108 is disposed on the connection portion 1118, for example. The connection portion 1118 may be made of polymer, a wax film, and so on. In this embodiment, the connection portion 1118, for example, is a plastic rope, which should not be construed as a limitation to this invention.

In FIG. 11B, when the connection portion 1118′ is melted by the heating apparatus 1108 located on the connection portion 1118′, the connection rod 1114 fixed by the connection portion 1118′ is released. The connection rod 1114 is moved from the first position to the second position with gravity, such that the first reactant 1104 connecting the bottom portion of the connection rod 1114 falls into and reacts with the second reactant 1106 to generate hydrogen gas.

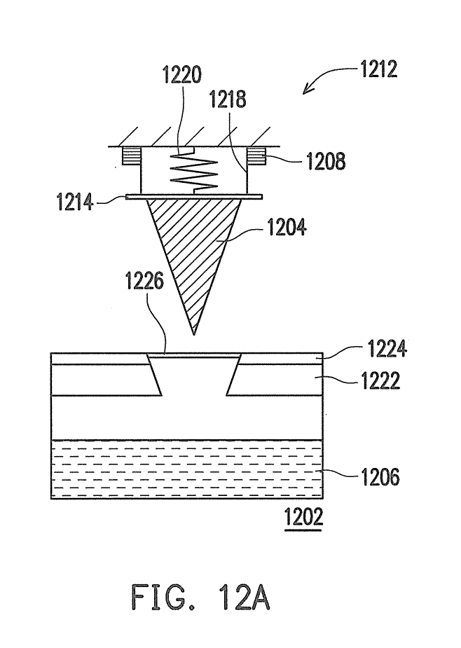

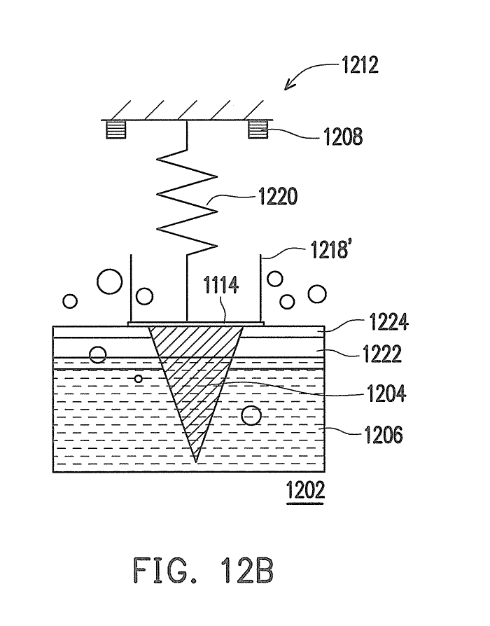

FIG. 12A and FIG. 12B are schematic cross-sectional views illustrating operation of a reaction unit in a fuel cartridge according to another embodiment of the invention.

In FIG. 12A, the fuel cartridge includes a plurality of reaction units 1202. Each of the reaction units 1202 includes a first reactant 1204, a second reactant 1206, and heating apparatuses 1208. The first reactant 1204 and the second reactant 1206 are separated from each other. Each of the reaction units 1202 further includes a fixing mechanism 1212 for separating the first reactant 1204 from the second reactant 1206, for example. In an embodiment, the fixing mechanism 1212 includes a connection rod 1214 connecting the first reactant 1204, connection portions 1218, and an elastic member 1220. The elastic member 1220 connects the connection rod 1214 to exert an elastic force on the connection rod 1214. Here, the elastic member 1220 is, for example, a spring. The connection portions 1218 connect the connection rod 1214 to press the elastic member 1220 and fix the connection rod 1214 at a first position. In this embodiment, two connection portions 1218 connecting an upper portion of the connection rod 1214 hang the connection rod 1214 up, for example, which should not be construed as a limitation to this invention. The heating apparatuses 1208 are disposed on the connection portions 1218, for example. The connection portions 1218 may be made of polymer, a wax film, and so on. In this embodiment, the connection portions 1218, for example, are plastic ropes, which should not be construed as a limitation to this invention.

In an embodiment, each of the reaction units 1202 may further include water absorbent cotton 1222, a breathable impervious film 1224, and an aluminum foil hole 1226. The water absorbent cotton 1222 and the breathable impervious film 1224 are disposed in the chamber accommodating the second reactant 1206, for example. The aluminum foil hole 1226 is used to seal the chamber accommodating the second reactant 1206, for example. The first reactant 1204 connecting the connection rod 1214 is correspondingly hung above the aluminum foil hole 1226, and the first reactant 1204 has a pointed shape, for instance.

With reference to FIG. 12B, when electrical quantity of the fuel cell stack is detected to be insufficient, the heating apparatuses 1208 in one or more of the reaction units 1202 may be activated based on power consumption of the fuel cell stack to conduct electricity and perform heating. The connection portions 1218′ are melted by the heat of the heating apparatuses 1208 located on the connection portions 1218′, such that the connection rod 1214 fixed by the connection portions 1218′ is released. The connection rod 1214 is moved from the first position to the second position with gravity, such that the pointed first reactant 1204 connecting the bottom portion of the connection rod 1214 passes through the aluminum foil hole 1226 and reacts with the second reactant 1206 to generate hydrogen gas. Besides, when the first reactant 1204 falls into the second reactant 1206 due to the elastic force exerted by the elastic member 1220, the second reactant 1206 is not split over because the water absorbent cotton 1222 and the breathable impervious film 1224 are disposed in the chamber accommodating the second reactant 1206. As such, the generate hydrogen gas passes through the breathable impervious film 1224 and is supplied to the fuel cell stack.

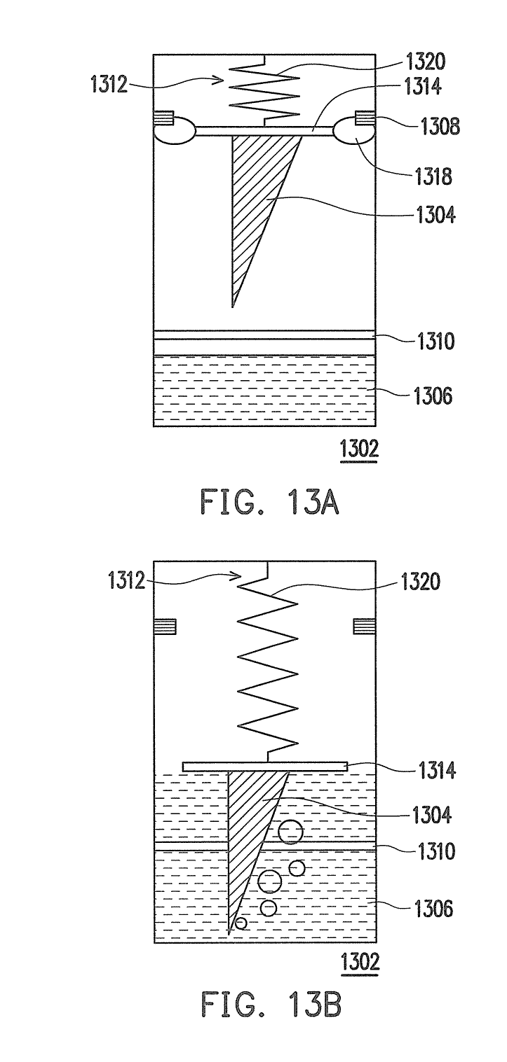

FIG. 13A and FIG. 13B are schematic cross-sectional views illustrating operation of a reaction unit in a fuel cartridge according to another embodiment of the invention.

In FIG. 13A, the fuel cartridge includes a plurality of reaction units 1302. Each of the reaction units 1302 includes a first reactant 1304, a second reactant 1306, and heating apparatuses 1308. The first reactant 1304 and the second reactant 1306 are separated from each other. Each of the reaction units 1302 further includes a fixing mechanism 1312 for separating the first reactant 1304 from the second reactant 1306, for example. In an embodiment, the fixing mechanism 1312 includes a connection rod 1314 connecting the first reactant 1304, connection portions 1318, and an elastic member 1320. The elastic member 1320 connects the connection rod 1314 to exert an elastic force on the connection rod 1314. Here, the elastic member 1320 is, for example, a spring. The connection portions 1318 connect the connection rod 1314 to press the elastic member 1320 and fix the connection rod 1314 at a first position. In this embodiment, the connection portions 1318 are respectively disposed at two sides of the connection rod 1314 and connected to an inner wall of the chamber, for example, such that the connection rod 1314 is fixed by the connection portions 1318, which should not be construed as a limitation to this invention. The heating apparatuses 1308 are disposed on the connection portions 1318, for example. The connection portions 1318 may be made of polymer, a wax film, and so on.

Besides, the chamber of the reaction unit 1302 further includes a thin film 1310, such that a portion of the chamber accommodating the second reactant 1306 forms a closed space. The first reactant 1304 has a pointed shape, for example.

With reference to FIG. 13B, when electrical quantity of the fuel cell stack is detected to be insufficient, the heating apparatuses 1308 in one or more of the reaction units 1302 may be activated based on power consumption of the fuel cell stack to conduct electricity and perform heating. The connection portions 1318 fixing the connection rod 1314 are melted by the heat of the heating apparatuses 1308 in each of the reaction units 1302, such that the connection rod 1314 fixed by the connection portions 1318 is released. The connection rod 1314 is moved from the first position to the second position with gravity. As such, the pointed first reactant 1304 on the connection rod 1314 may penetrate the thin film 1310 and react with the second reactant 1306 to generate the hydrogen gas.

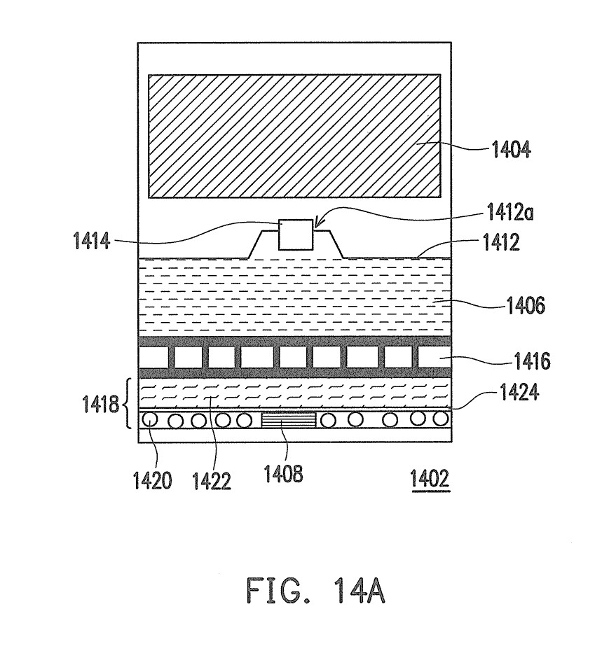

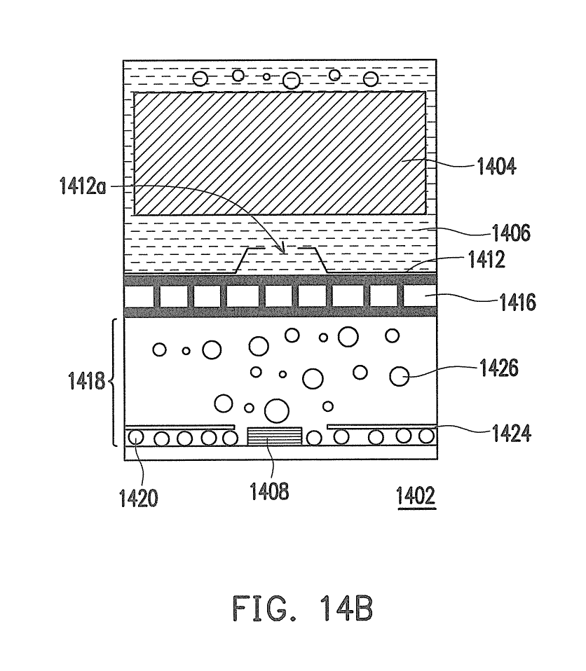

In other embodiments, together with a gas generator, the separated first and second reactants may contact with each other to generate the hydrogen gas. Detail description is provided hereinafter. FIG. 14A and FIG. 14B are schematic cross-sectional views illustrating operation of a reaction unit in a fuel cartridge according to an embodiment of the invention.

In FIG. 14A, the fuel cartridge includes a plurality of reaction units 1402. Each of the reaction units 1402 includes a first reactant 1404, a second reactant 1406, and a heating apparatus 1408. The first reactant 1404 and the second reactant 1406 are separated from each other. In this embodiment, a separation member 1412, a plug 1414, and a piston 1416 are disposed in the chamber of each of the reaction units 1402. The first reactant 1404 and the second reactant 1406 are respectively disposed at two sides of the separation member 1412, and the second reactant 1406 is placed in the closed space between the separation member 1412 and the piston 1416. The separation member 1412 has an opening 1412a, for example. The plug 1414 is lodged at the opening 1412a to seal the separation member 1412.

Besides, each of the reaction units 1402 further includes a gas generator 1418 disposed below the piston 1416. The gas generator 1418, for example, is used to generate gas for moving the piston 1416 located in the chamber, such that the separated first and second reactants 1404 and 1406 contact with each other for gas generation reaction. In an embodiment, the gas generator 1418 includes a third reactant 1420, a fourth reactant 1422, and a thin film 1424. The thin film 1424 separates the third reactant 1420 from the fourth reactant 1422. The heating apparatus 1408 connects the thin film 1422. For instance, the heating apparatus 1408 is disposed on a surface of the thin film 1422, so as to melt the thin film 1422 by heating. Thereby, the separated third and fourth reactants 1420 and 1422 contact with each other to generate gas. The third reactant 1420 is powder, for example, and the fourth reactant 1422 is any liquid, for example, which should not be construed as limitations to this invention. People skilled in the art are able to modify the materials and the types of the third and the fourth reactants 1420 and 1422 as long as gas may be generated after the third and the fourth reactants 1420 and 1422 contact with each other.

With reference to FIG. 14B, when electrical quantity of the fuel cell stack is detected to be insufficient, the heating apparatus 1408 in one of the reaction units 1402 or the heating apparatuses 1408 in more of the reaction units 1402 may be activated based on power consumption of the fuel cell stack to conduct electricity and perform heating. The heating apparatus 1408 located on the surface of the thin film 1424 melts the thin film 1424 by heating and forms holes through which the third reactant 1420 and the fourth reactant 1422 separated by the thin film 1424 contact with each other for generating gas 1426. The gas 1426 exerts pressure on the piston 1416, so as to move the piston 1416 along a direction toward the separation member 1412. Namely, the piston 1416 is moved toward the top portion of FIG. 14B. When the gas 1426 from the gas generator 1418 exerts pressure on the piston 1416 and moves the piston 1416 upward, the second reactant 1406 located above the piston 1416 is pushed to press the plug 1414 lodged at the opening 1412a. As such, the plug 1414 is moved out of the opening 1412a. Consequently, the second reactant 1406 may be pressed to the other side of the separation member 1412 after the second reactant 1406 passes through the opening 1412a, and the second reactant 1406 reacts with the first reactant 1404 to generate an adequate quantity of hydrogen gas.

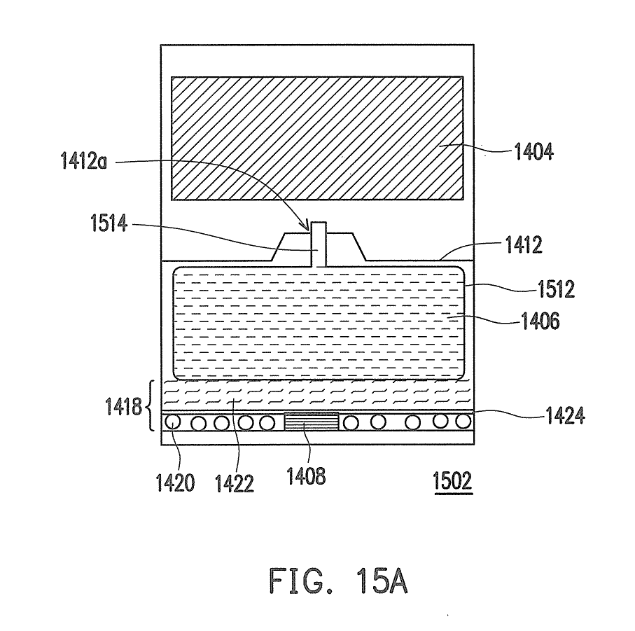

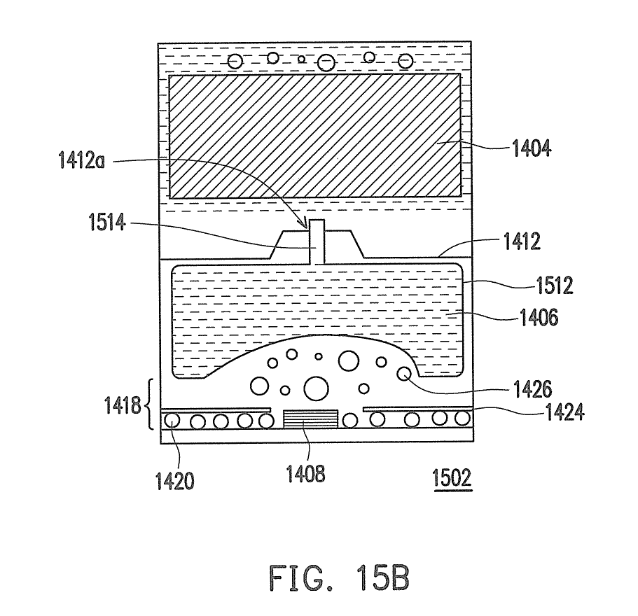

Besides, in another embodiment, the second reactant located between the separation member and the piston in the closed space may also be arranged in another fashion. FIG. 15A and FIG. 15B are schematic cross-sectional views illustrating operation of a reaction unit in a fuel cartridge according to another embodiment of the invention. Same components in FIG. 15A and FIG. 15B and in FIG. 14A and FIG. 14B are marked by the same reference numbers, and relevant description is omitted herein.

According to another embodiment, the major components of the reaction units 1502 depicted in FIG. 15A are basically the same as those of the reaction units 1402 depicted in FIG. 14A, while the difference therebetween lies in the closed space accommodating the second reactant. In FIG. 15A, the second reactant 1406 is located in a shape-able container 1512, for example. The container 1512 has a nozzle 1514 through which the second reactant 1406 in the container 1512 may be injected. The nozzle 1514 is lodged at the opening 1412a to seal the separation member 1412, for example. The container 1512 is a water bag, for example, which is not limited in this invention. Additionally, the gas generator 1418 is disposed below the container 1512, for example.

With reference to FIG. 15B, when electrical quantity of the fuel cell stack is detected to be insufficient, the heating apparatus 1408 in one of the reaction units 1502 or the heating apparatuses 1408 in more of the reaction units 1502 may be activated based on power consumption of the fuel cell stack to conduct electricity and perform heating. In each of the reaction units 1502, the heating apparatus 1408 located on the surface of the thin film 1424 melts the thin film 1424 by heating and forms holes through which the third reactant 1420 and the fourth reactant 1422 separated by the thin film 1424 contact with each other for generating gas 1426. The gas 1426 generated from the gas generator 1418 exerts pressure on the shape-able container 1512, and thus a bottom of the container 1512 is deformed and becomes concave. When the container 1512 on which the gas 1426 exerts pressure is deformed and becomes concave, the second reactant 1406 in the container 1512 is pushed out of the container 1512. Consequently, the second reactant 1406 may be injected out of the container 1512 to the other side of the separation member 1412 after the second reactant 1406 passes through the nozzle 1514, and the second reactant 1406 reacts with the first reactant 1404 to generate an adequate quantity of hydrogen gas.

In light of the foregoing, the invention has at least one of the advantages described below. The fuel cartridge has a plurality of reaction units, and the first reactant and the second reactant in each of the reaction units are separated from each other. Hence, when the electrical quantity of the fuel cell stack is detected to be insufficient, the heating apparatus in one of the reaction units or the heating apparatuses in more of the reaction units may be activated based on power consumption of the fuel cell stack to conduct electricity and perform heating, such that the separated first and second reactants contact with each other to perform the chemical reaction by which an adequate quantity of hydrogen gas may be generated and supplied to the fuel cell stack. Thereby, the amount of the hydrogen gas generated in the fuel cartridge may be actively controlled without being wasted.

In addition, a solid chemical hydrogen storage material is used for accomplishing the high hydrogen gas storage rate according to the embodiments of the invention. Moreover, each of the reaction units has a constant amount of the first and the second reactants, such that the chemical reaction may be completely conducted.

On the other hand, the reaction between the reactants is actively controlled by the heating apparatus instead of complicated mechanisms, such as pumps and valves. As a result, the manufacturing costs may be reduced, and the fuel cartridge may be miniaturized.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A fuel cartridge comprising:
a plurality of reaction units, each of the reaction units comprising:
a first reactant and a second reactant separated from each other; and
a heating apparatus, wherein the heating apparatus is capable of making the first reactant and the second reactant separated from each other contact with each other to generate hydrogen gas.

2. The fuel cartridge as claimed in claim 1, wherein each of the reaction units further comprises a thin film separating the first reactant from the second reactant.

3. The fuel cartridge as claimed in claim 2, wherein the heating apparatus is connected to the thin film, and the heating apparatus is capable of melting the thin film by heating, such that the first reactant and the second reactant contact with each other.

4. The fuel cartridge as claimed in claim 3, further comprising at least a pressing mechanism pushing the first reactant to the second reactant or pushing the second reactant to the first reactant when the heating apparatus melts the thin film by heating.

5. The fuel cartridge as claimed in claim 2, the thin film having a closed space, wherein one of the first reactant and the second reactant is located in the closed space, and the other is located outside the closed space.

6. The fuel cartridge as claimed in claim 5, each of the reaction units further comprising a capsule disposed in the closed space of the thin film, the capsule having a reactant different from the one of the first reactant and the second reactant located in the closed space, wherein the heating apparatus is connected to the capsule and is capable of melting the capsule by heating, such that the reactant located in the capsule contacts with the other one of the first reactant and the second reactant located outside the capsule to generate gas.

7. The fuel cartridge as claimed in claim 6, each of the reaction units further comprising a pointed member disposed outside the closed space of the thin film, wherein the pointed member penetrates the thin film when the gas is generated to inflate the thin film, such that the first reactant and the second reactant separated by the thin film contact with each other to generate the hydrogen gas.

8. The fuel cartridge as claimed in claim 2, wherein each of the reaction units further comprises a thin film destruction mechanism having a pointed member to penetrate the thin film, such that the first reactant and the second reactant separated by the thin film contact with each other.

9. The fuel cartridge as claimed in claim 8, the thin film destruction mechanism comprising:
a connection rod where the pointed member is disposed;
an elastic member connecting the connection rod to exert an elastic force on the connection rod; and
a connection portion connecting the connection rod to fix the connection rod at a first position, the heating apparatus connecting the connection portion,
wherein the connection rod is moved from the first position to a second position when the heating apparatus melts the connection portion by heating, such that the pointed member on the connection rod penetrates the thin film, and the first reactant and the second reactant contact with each other.

10. The fuel cartridge as claimed in claim 2, wherein the thin film is made of a material which does not react with the first reactant and the second reactant.

11. The fuel cartridge as claimed in claim 1, each of the reaction units further comprising a fixing mechanism, the fixing mechanism comprising:
a connection rod connecting the first reactant;
an elastic member connecting the connection rod to exert an elastic force on the connection rod; and
a connection portion connecting the connection rod to fix the connection rod at a first position, the heating apparatus connecting the connection portion,
wherein the first reactant connecting the connection rod is moved from the first position to a second position when the heating apparatus melts the connection portion by heating, such that the first reactant and the second reactant contact with each other.

12. The fuel cartridge as claimed in claim 11, wherein the first reactant has a pointed shape.

13. The fuel cartridge as claimed in claim 1, each of the reaction units further comprising a gas generator capable of generating a gas, the gas being capable of pushing the second reactant to the first reactant.

14. The fuel cartridge as claimed in claim 13, the gas generator comprising:
a third reactant and a fourth reactant separated from each other; and
a thin film separating the third reactant from the fourth reactant, wherein the heating apparatus is connected to the thin film, and the heating apparatus is capable of melting the thin film by heating, such that the third reactant and the fourth reactant contact with each other to generate the gas.

15. The fuel cartridge as claimed in claim 1, further comprising an external control circuit respectively connecting the heating apparatus of each of the reaction units, the external control circuit being capable of selectively controlling at least one of the heating apparatuses in at least one of the reaction units to perform heating.

16. The fuel cartridge as claimed in claim 1, wherein the first reactant comprises a chemical hydrogen storage material, and the second reactant comprises a hydro-reactant.

17. The fuel cartridge as claimed in claim 16, wherein the chemical hydrogen storage material is selected from the group consisting of metal, metal hydride, borohydride, aluminum hydride, hydrocarbon, and ammonium hydride.

18. The fuel cartridge as claimed in claim 16, wherein the hydro-reactant is liquid water or solid water.

19. The fuel cartridge as claimed in claim 1, wherein the heating apparatus is a resistor or an electrically heated wire.

20. A hydrogen storage method comprising:
providing a fuel cell system comprising a fuel cell stack and a fuel cartridge, the fuel cartridge having a plurality of reaction units, each of the reaction units comprising a first reactant, a second reactant, and a heating apparatus, wherein the first reactant and the second reactant are separated from each other;
detecting electric quantity of the fuel cell stack;
performing a first hydrogen generation reaction based on power consumption of the fuel cell stack to generate hydrogen gas when the electric quantity of the fuel cell stack is insufficient, the first hydrogen generation reaction comprising:
controlling at least one of the heating apparatuses in at least one of the reaction units to perform heating, such that the first reactant and the second reactant in at least one of the reaction units contact with each other to generate the hydrogen gas; and
supplying the fuel cell stack with the hydrogen gas generated by performing the first hydrogen generation reaction.

21. The hydrogen storage method as claimed in claim 20, wherein the at least one of the reaction units that is controlled is not adjacent to another.

22. The hydrogen storage method as claimed in claim 20, further comprising detecting the electric quantity of the fuel cell stack again after the first hydrogen generation reaction is performed and performing a second hydrogen generation reaction based on another power consumption of the fuel cell stack to generate the hydrogen gas when the electric quantity of the fuel cell stack is insufficient, the second hydrogen generation reaction comprising:
controlling at least another one of the heating apparatuses in at least another one of the reaction units to perform heating, such that the first reactant and the second reactant in at least another one of the reaction units contact with each other to generate the hydrogen gas.

23. The hydrogen storage method as claimed in claim 20, wherein the at least another one of the reaction units used in the second hydrogen generation reaction is different from and separated from the at least one of the reaction units used in the first hydrogen generation reaction.

24. The hydrogen storage method as claimed in claim 20, wherein the first reactant comprises a chemical hydrogen storage material, and the second reactant comprises a hydro-reactant.

25. The hydrogen storage method as claimed in claim 24, wherein the chemical hydrogen storage material is selected from the group consisting of metal, metal hydride, borohydride, aluminum hydride, hydrocarbon, and ammonium hydride.

26. The hydrogen storage method as claimed in claim 24, wherein the hydro-reactant is liquid water or solid water.

27. The hydrogen storage method as claimed in claim 20, wherein the heating apparatus is a resistor or an electrically heated wire.
